(19) United States
(12) Patent Application Publication
(10) Pub. No.: US 2019/0245479 A1
(43) Pub. Date: Aug. 8, 2019

(54) DRAG REDUCING SOLAR PANEL VEHICLE COVER

(71) Applicant: Naseem Zain Shah, Scottsdale, AZ (US)

(72) Inventor: Naseem Zain Shah, Scottsdale, AZ (US)

(21) Appl. No.: 15/837,076

(22) Filed: Dec. 11, 2017

(51) Int. Cl. H02S 30/10; B60L 8/00; B60K 1/04; H02S 20/30

(52) U.S. Cl. CPC H02S 30/10; H02S 20/30; B60K 1/04; B60L 8/006

(57) ABSTRACT

A drag reducing, solar panel vehicle cover is fastened onto the exterior parts of a vehicle namely the roof, hood, doors, fenders, and trunk. The vehicle cover has a generally indented shell made of thin wall metal with a thin film solar panel outer surface; the vehicle cover having a shape that conforms to the respective exterior part of the vehicle so that it mates with and overlaps the part. The surface of the vehicle cover is polished and plasma is generated above the surface through judiciously positioned plasma actuators which inhibit the separation of airflow when the vehicle is in motion, thereby reducing drag. The vehicle cover serves three objectives. It charges the onboard battery rack through a thin film solar panel outer surface without altering the original form, shape or contour of the vehicle. It reduces drag through judiciously positioned plasma actuators on its surface. It gives the vehicle the appearance of having a solar panel like surface.

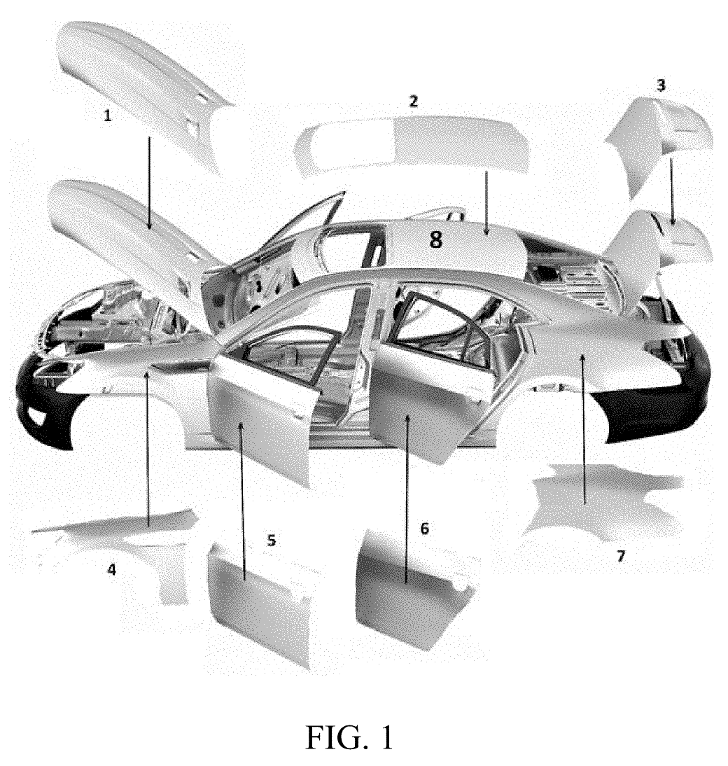

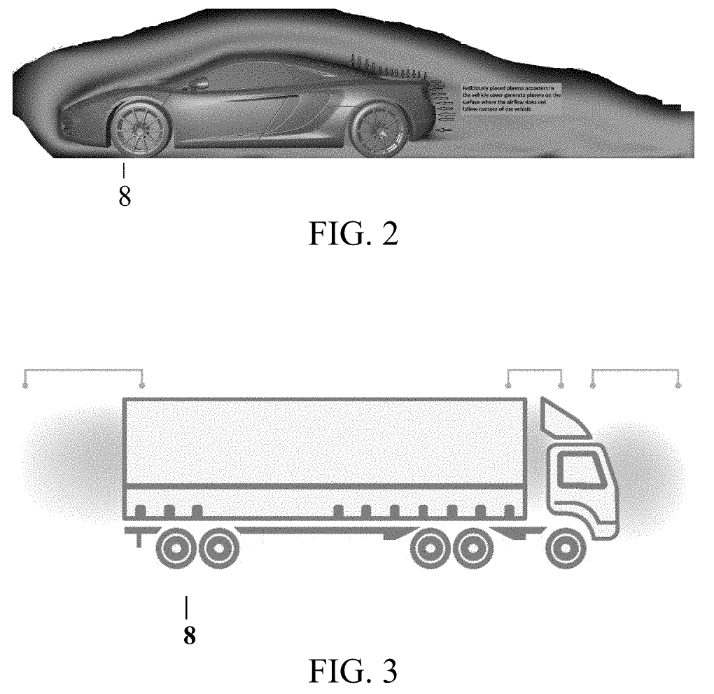

A drag reducing, solar panel vehicle cover is fastened onto the exterior parts of a vehicle namely the roof, hood, doors, fenders, and trunk. The vehicle cover has a generally indented shell made of thin wall metal with a thin film solar panel outer surface; the vehicle cover having a shape that conforms to the respective exterior part of the vehicle so that it mates with and overlaps the part. The surface of the vehicle cover is polished and plasma is generated above the surface through judiciously positioned plasma actuators which inhibit the separation of airflow when the vehicle is in motion, thereby reducing drag. The vehicle cover serves three objectives. It charges the onboard battery rack through a thin film solar panel outer surface without altering the original form, shape or contour of the vehicle. It reduces drag through judiciously positioned plasma actuators on its surface. It gives the vehicle the appearance of having a solar panel like surface.

### FIELD OF THE INVENTION

This invention relates to Vehicles. More particularly, this invention relates to a drag reducing, solar panel vehicle cover that charges the onboard battery rack, reduces drag and gives the vehicle the appearance of a solar panel like surface.

### BACKGROUND OF THE INVENTION

The demand for hybrid, plug-in hybrid or all-electric drive vehicles will continue to climb as prices drop and consumers look for ways to save money. Fuel efficiency is another major objective of the auto industry. Higher drag is a source of higher fuel consumption.

The drag reducing, solar panel vehicle cover provides a way to charge these vehicles through a thin wall solar panel cover having the shape that conforms to the exterior parts of the vehicle so that it mates with and overlaps the respective part. Since the cover is in the same shape as the exterior parts it retains the original form, shape and contour of the vehicle.

Vehicles have surfaces where the airflow does not follow the contour of the vehicle. This results in increased drag. But when plasma is created on those surfaces it inhibits the separation of the airflow from vehicle's surface thereby decreasing drag resulting in better fuel efficiency. Plasma is generated above the surface of the cover through judiciously positioned plasma actuators comprising a dielectric, to help reduce drag.

The vehicle cover also acts as a glass skin made of a thin film solar panel giving the vehicle a refined look.

### SUMMARY OF THE INVENTION

One general object of this invention is to provide solar charging capability to hybrid, plug-in hybrid or all-electric vehicles without altering the original form, shape or contour of the vehicle. Another general object of this invention is to provide a method of reducing drag by creating plasma on its surface through judiciously positioned plasma actuators comprising a dielectric in the area where the airflow separates from the contour of the vehicle.

I have invented drag reducing, solar panel vehicle covers for the exterior parts of a vehicle. Solar panels generally have a flat surface and do not conform to the exact shape of various parts of a vehicle. The invented vehicle cover comprises of a thin wall metal, preferably aluminum, having a thin film solar panel outer surface with plasma actuators judiciously positioned in the area in which airflow separates from the contour of the vehicle. The vehicle cover has a shape that conforms the exterior parts of the vehicle so that it mates with and overlaps the respective parts; namely the roof, hood, doors, fenders, and trunk.

The method comprises fastening onto the exterior parts of a vehicle, solar panel covers, having generally an indented shell made of thin wall metal with a thin film solar panel outer surface and judiciously positioned plasma actuators. The cover has a shape that conforms to the exterior parts so that it mates with and overlaps these parts.

The cover of this invention is lightweight, durable, easy to install, and provides solar charging capability to the vehicle in addition to reducing drag by creating plasma on the surface where the airflow separates from the contour of the vehicle. It also gives it the appearance of being made from a solar panel.

One general object of this invention is to provide solar charging capability to hybrid, plug-in hybrid or all-electric vehicles without altering their shape or contour. Another general object of this invention is to reduce drag while giving the vehicle the appearance of having been made from a solar panel.

### BRIEF DESCRIPTION OF THE DRAWINGS

Diagram 1 is a perspective view of a preferred embodiment of the drag reducing, solar panel vehicle covers of this invention being installed on a vehicle.

Diagram 2 is a perspective view of a preferred embodiment of the judicious positioning of plasma actuators on the surface of the cover based on the separation of airflow.

Diagram 3 is a perspective view of a preferred embodiment of plasma being generated through the judicious positioning of plasma actuators on the surface of the cover based on the separation of airflow.

### DETAILED DESCRIPTION OF THE INVENTION

This invention is best understood by reference to drawing 1. A preferred embodiment of the drag reducing, solar panel vehicle covers 1, 2, 3, 4, 5, 6 and 7 of the present invention are shown being installed on a vehicle 8. The cover is shaped to mate closely with the respective vehicle part so that it tightly and completely overlaps the part. When installed, the shape of the vehicle is unchanged. The only difference is that the surface of the exterior part is a thin film solar panel instead of metal, polymer or carbon fiber. The covers are connected to an on-board battery pack through leads that run inside the vehicle. The thin film solar panel helps charge the on-board battery racks.

In addition, the cover helps in reducing drag by creating plasma on its surface through judiciously positioned plasma actuators comprising a dielectric in the area where the airflow separates from the surface as shown in drawing 2 and drawing 3.

Based on their respective shape vehicles have surfaces where the airflow does not follow the contour of the vehicle. When plasma is created on those surfaces it inhibits the separation of the airflow thereby decreasing drag resulting in better fuel economy.

The protection given to the vehicle is not diminished by the addition of the vehicle cover. Accordingly, the vehicle cover itself need not contribute to the protection. Furthermore, when the vehicle cover mates closely with the respective part, the cover is supported by the underlying part. The vehicle cover is a relatively thin, lightweight shell made of a thin sheet metal, preferably aluminum, covered with a thin film solar panel with judiciously positioned plasma actuators based on the shape of the vehicle.

The preferred embodiment of the vehicle cover is installed onto the respective part with tape, adhesive, fasteners, or the like. When installed, the vehicle cover gives the appearance of a solar panel cast in the shape of the respective part.

Although the preferred embodiment of the vehicle cover of this invention has a shape and size similar to the exterior part it covers, the vehicle cover may, if desired, have a different shape and/or size. The vehicle cover of this invention is suitable for use on any type of vehicle.

I claim:

1. Drag reducing, solar panel vehicle cover for exterior parts of vehicles namely the roof, hood, doors, fenders, and trunk; the vehicle cover comprising a generally indented shell made of thin wall metal having a thin-film solar panel outer surface, the vehicle cover having a shape that conforms to the exterior of the respective part so that it mates with and overlaps the part. The surface of the vehicle cover is polished and plasma is generated above the surface through judiciously positioned plasma actuators.

2. The drag reducing, solar panel vehicle cover of claim 1 wherein the vehicle cover is made of thin wall metal with a thin-film solar panel outer surface having a thickness of less than about 0.25 inches with judiciously positioned plasma actuators based on the specific design of the vehicle.

3. A method of modifying a vehicle to give it the appearance of having a solar panel like surface, the method comprising fastening onto the vehicle exterior parts a thin wall metal with a thin-film solar panel outer surface having a shape that conforms to the exterior of the respective part so that it mates with and overlaps the respective part.

4. The method of claim 3 wherein the solar panel shell with judiciously positioned plasma actuators are fastened onto the vehicle with tape, adhesive, or fasteners and connected to the onboard battery rack through leads.
